(19) United States
(12) Patent Application Publication
(10) Pub. No.: US 2003/0117248 A1
(43) Pub. Date: Jun. 26, 2003

(54) Removable mounting bracket

(76) Inventors: Richard William St. John, Ann Arbor, MI (US); William Douglas Walker, Saline, MI (US); Todd Christopher Sexton, Ypsilanti, MI (US); Alex William Widiger, Canton, MI (US); Robert Lloyd Huotari, Fenton, MI (US)

Correspondence Address: MACMILLAN, SOBANSKI & TODD, LLC, ONE MARITIME PLAZA-FOURTH FLOOR, 720 WATER STREET, TOLEDO, OH, 43604, US

(21) Appl. No.: 10/035,685

(22) Filed: Dec. 26, 2001

(51) Int. Cl. H01F 27/06

(52) U.S. Cl. 336/67

(57) ABSTRACT

A removable mounting bracket for attaching a component to a mounting surface includes a bracket body having a mounting projection and a plurality of elongated retaining members extending outwardly therefrom. The mounting projection cooperates with a fastener for fastening the component to the mounting surface. At least one of the retaining members has an aperture formed therein that releasably engages a corresponding plurality of mounting tabs formed on the component.

### BACKGROUND OF THE INVENTION

The present invention relates generally to ignition coil assemblies for spark-ignition internal combustion engines and, in particular, to a removable mounting bracket for an ignition coil assembly.

Ignition coil assemblies for automotive spark-ignition internal combustion engines are well known. Spark-ignition internal combustion engines require the use of spark plugs to ignite a fuel-air mixture that has been introduced into the various combustion cylinders of the engine. The spark plugs are typically disposed in threaded holes in the cylinder head. One end of each spark plug includes gapped electrodes and extends into the combustion cylinder. An opposite end of each spark plug includes an electrical terminal and extends outwardly from the cylinder head.

In order to generate a spark across the gapped electrodes, each spark plug requires a supply of electricity that is provided by an ignition system. Traditionally a single ignition coil having a wound primary coil and a wound secondary coil was used connected to the spark plugs by a distributor. More recently, an ignition coil assembly is provided for each spark plug wherein the secondary coil of each coil assembly is electrically connected to the terminal of a corresponding spark plug. At the proper time in the engine operating cycle for firing a particular spark plug, electric current flowing through the primary of the respective ignition coil assembly is abruptly interrupted to induce a voltage in the secondary coil sufficiently high to create a spark across the gapped electrodes of the spark plug, igniting the combustible fuel-air mixture to power the engine.

Prior art ignition systems utilize various types of ignition coil assemblies. One type of ignition coil assembly is inserted substantially inside the spark plug insertion bore in the cylinder head combustion engine. This type of coil assembly is known in the art by various names including a pencil coil, a stick coil, a plug hole coil, and a cigar coil. Another type of ignition coil assembly includes a boot that is retained in the engine cover. The magnetic circuit components, including the primary and secondary coils, of this type of ignition coil are housed above the spark plug insertion hole and attached to the boot. This type of coil assembly is known in the art by various names including a coil on plug, plug top coil, and coil per plug.

Regardless of the type of ignition coil assembly, prior art ignition coil assemblies typically have been mounted to a mounting surface in the engine compartment, such as the cam cover or the cylinder head, by an external bracket or mounting arm. The mounting arm typically includes a mounting boss extending outwardly therefrom through which a fastener is inserted to attach the ignition coil to the mounting surface. In these prior art ignition coil assemblies, however, the mounting arm is part of the molded structure of the ignition coil assembly and cannot be removed or relocated. Any change to the mounting configuration of the prior art ignition coil assemblies, therefore, disadvantageously requires the entire structure of the ignition coil assembly to be modified. In addition, this structural modification is often prohibitively expensive.

It is desirable to provide a means for changing the mounting configuration of an ignition coil assembly by making a simple and cost-effective change to the mounting arm alone, without requiring an expensive change to the entire ignition coil structure.

### SUMMARY OF THE INVENTION

The present invention concerns a removable mounting bracket for attaching to a component, preferably an ignition coil assembly, which is then further attached to a mounting surface, such as a cam cover, a valve cover, or a cylinder head, in an internal combustion engine compartment.

The mounting bracket includes a bracket body and a means for releasably attaching the bracket body to the ignition coil assembly. The bracket body is preferably constructed of injection molded plastic or a similar material. Preferably, the means for releasably attaching the bracket body to the ignition coil assembly is a plurality of spaced apart retaining members extending outwardly from an exterior surface of the bracket body. At least one of the retaining members includes a releasable attachment means attached thereto, preferably on an exterior surface thereof. Alternatively, each of the retaining members includes a releasable attachment means attached on an exterior surface thereof. The retaining members have a dual function. The first function is to attach the bracket body to the component. The second function is to assist in retaining the assembled bracket body and component to the mounting surface. The releasable attachment means engage with corresponding mounting means on an exterior surface of the ignition coil assembly when the mounting bracket is mounted on the ignition coil assembly. The retaining members and a portion of the exterior surface of the bracket body define a mounting recess therebetween for cooperating with the exterior surface of the ignition coil assembly. The exterior surface of the bracket body disposed within the mounting recess preferably includes a plurality of ribs and grooves for cooperating with the exterior surface of the ignition coil assembly. The exterior surface of the ignition coil assembly is adapted to conform to the mounting recess of the mounting bracket.

An integral mounting projection having a cylindrical aperture formed therethrough extends outwardly from the bracket body. The aperture in the mounting projection receives a tubular mounting insert that is preferably constructed of aluminum, brass, thermoset plastic, or similar material. The mounting insert receives a fastener that permits fastening the assembled mounting bracket and ignition coil assembly to the mounting surface of the engine.

When the ignition coil assembly is ready to be attached to the mounting surface, the mounting bracket is first mounted to the ignition coil assembly. The mounting means on the retaining members engage with the corresponding locking means on the exterior surface of the ignition coil assembly. The ribs and grooves on the exterior surface of the mounting bracket engage a plurality of corresponding ribs and grooves on the exterior surface of the ignition coil assembly, advantageously enhancing the mounting rigidity. A fastener is then placed in the aperture in the mounting projection and fastened to a boss extending from the mounting surface.

The design of the present invention advantageously reduces manufacturing complexity because the same base ignition coil assembly can be produced on a single assembly line, with no tool changeover. Each specific part application would only require different mounting brackets during final assembly, which further promotes production flexibility by delaying the addition of application specific components, such as the mounting bracket, to the end of the manufacturing process. The present invention also provides the ability to mount the same base ignition coil, using different mounting geometries, on the same engine.

The present invention provides a means for securely attaching the ignition coil assembly to the engine while also providing the flexibility of removing the mounting bracket from the ignition coil assembly if other attachment methods are preferred. The present invention offers flexibility in packaging the same design ignition coil assembly in a variety of mounting configurations without major modifications to the ignition coil assembly structure.

In addition, the present invention allows modifications to be made to the engine and cam cover configuration by changing only the mounting bracket when supporting engine prototype builds. This provides a great advantage over prior art mounting technologies, which required costly modifications to the entire ignition coil structure when engine or cam cover changes were made.

Furthermore, by removing the mounting bracket from the ignition coil assembly, the mounting bracket is not subjected to the heat and stress of the combustion cylinders, as is the ignition coil assembly. The bracket, therefore, may be constructed of the material best suited for mounting, without needing to consider the best dielectric or thermal shock material, advantageously providing additional flexibility in the choice of the material for the mounting bracket.

The mounting bracket of the present invention is especially adapted for use with the pencil style ignition coil assemblies. Similar configurations for the mounting bracket, however, could be designed for the coil on plug style or other similar ignition coil assemblies. In addition, the present invention may be used with numerous types of internal combustion engines including, but not limited to, automotive engines, jet-ski engines, and snowmobile engines. The present invention also contemplates use with numerous types of components including, but not limited to, sensors and spark plug wire attachments while remaining within the scope of the invention.

### DESCRIPTION OF THE DRAWINGS

The above, as well as other advantages of the present invention, will become readily apparent to those skilled in the art from the following detailed description of a preferred embodiment when considered in the light of the accompanying drawings in which:

FIG. 1 is a bottom plan view of a mounting bracket in accordance with the present invention;

FIG. 2 is front elevation view of the mounting bracket shown in FIG. 1;

FIG. 3 is a perspective view of the mounting bracket shown in FIG. 1;

FIG. 4 is a perspective view of the mounting bracket shown in FIG. 1 mounted to an ignition coil assembly;

FIG. 5 is a perspective view of the mounting bracket and ignition coil assembly shown in FIG. 5 attached to a mounting surface;

FIG. 6 is a perspective view of an alternative embodiment of the mounting bracket.

FIG. 7 is a perspective view of the mounting bracket shown in FIG. 6 mounted to an ignition coil assembly.

### DESCRIPTION OF THE PREFERRED EMBODIMENT

Referring now to FIGS. 1, 2, and 3, a releasable mounting bracket for attaching to a component, preferably an ignition coil assembly, is indicated generally at 10. Alternatively, the mounting bracket 10 attaches to any number of components including, but not limited to, sensors and the like. The mounting bracket 10 is preferably constructed of an injection molded plastic material, or other similar material. The mounting bracket 10 includes a bracket body 12 having two elongated, generally rectangular side retaining members 14 extending outwardly therefrom. An a aperture 20 extends through each of the side retaining members 14. The inner surface at a free end of each of the retaining members 14 includes a ramped portion 18 formed thereon.

An elongated, generally rectangular upper retaining member 16 having an upper surface 24 and a lower surface 26 extends outwardly from the bracket body 12. An aperture 22 extends through the upper retaining member 16. Preferably, the upper retaining member 16 extends along the width of the bracket body 12.

An inner surface of the bracket body 12 bounded by the side retaining members 14 and the upper retaining member 16 includes a groove 38, a rib 40, a groove 42, a rib 44, and a groove 46, defining a mounting recess indicated generally at 49.

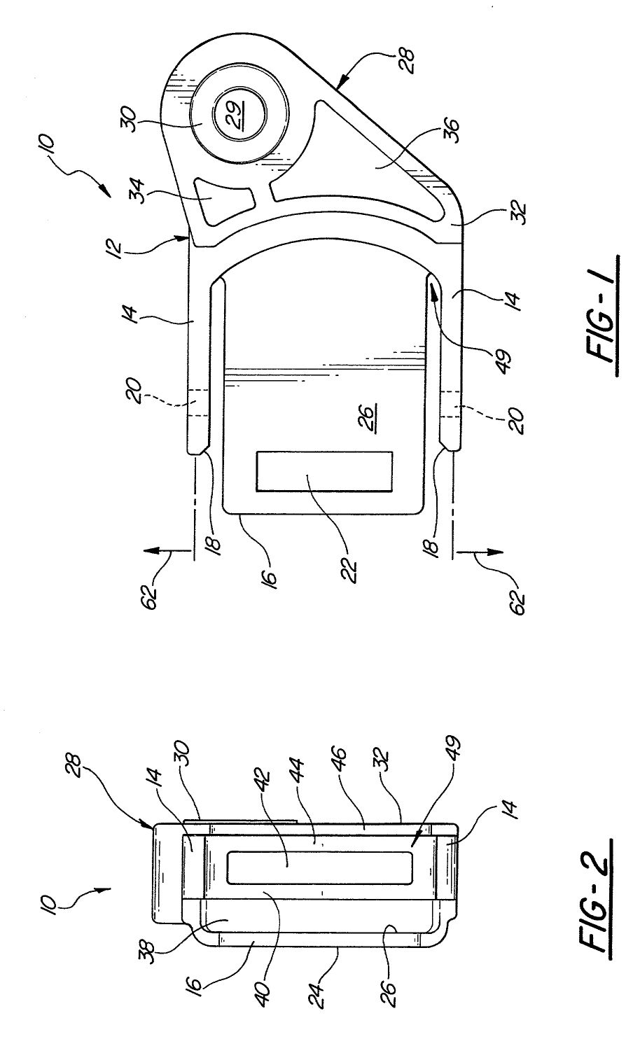

A mounting projection 28 extends from the bracket body 12 opposite the side retaining members 14 and the upper retaining member 16. A generally cylindrical aperture 29 extends through the mounting projection 28. The aperture 29 receives a generally tubular mounting insert 30. The mounting insert 30 is preferably constructed of aluminum, brass, thermoset plastic, or similar material. The mounting insert 30 is preferably sized to receive a fastener (not shown), outlined in more detail below. A portion of the mounting insert 30 extends below a lower surface 32, best seen in FIG. 2. A first recess 34 and a second recess 36 are formed in the lower surface 32 of the bracket body 12 for the purpose of improving the moldability of the bracket body 12 while also reducing the weight and the amount of material required to produce the mounting bracket 10.

Referring now to FIG. 4, the mounting bracket 10 is shown mounted to a pencil-type ignition coil assembly, indicated generally at 48. The ignition coil assembly 48 includes an upper portion 50 and a lower portion 52. A mounting tab 54 extends outwardly from opposed exterior surfaces of the upper portion 50 for engaging with the apertures 20 of the side retaining members 14. The mounting tabs 54 preferably include ramped portions formed thereon for assisting the mounting of the mounting bracket 10 to the ignition coil assembly 48. The grooves 38, 42, and 46 and the ribs 40 and 44 of the mounting recess 49 preferably interlock with corresponding ribs and grooves (not shown) on the exterior surface of the ignition coil assembly 48, reinforcing the connection between the bracket 10 and the ignition coil assembly 48.

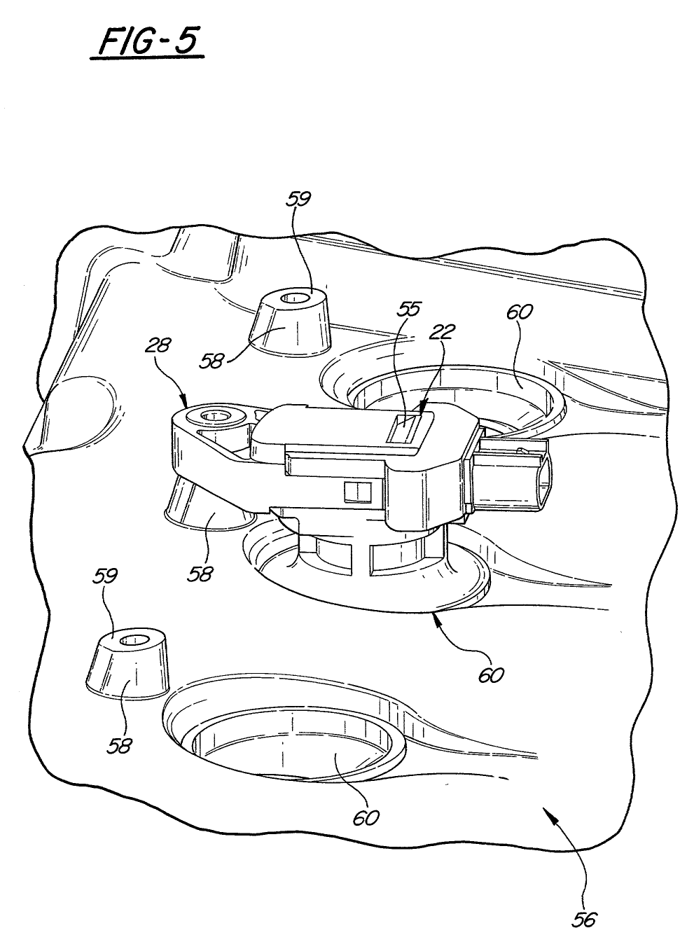

Referring now to FIG. 5, the combined mounting bracket 10 and ignition coil assembly 48 of FIG. 4 is shown attached to a mounting surface, indicated generally at 56, such as a cam cover or a cylinder head in an internal combustion engine compartment. The mounting surface 56 includes an upwardly extending mounting boss 58. The mounting boss 58 includes a planar mounting surface 59 for cooperating with the mounting insert 30 and the fastener (not shown), such as a bolt, a rivet, or the like. The mounting surface 56 preferably includes a plurality of apertures 60, such as spark plug holes, for receiving the lower portion 52 of the ignition coil assembly 48. Preferably, a plurality of mounting brackets 10 and ignition coil assemblies 48 are attached to a corresponding plurality of mounting projections 58. A mounting tab 55 extends upwardly from an upper exterior surface of the upper portion 50 of the ignition coil assembly 48 to engage with the aperture 22 in the upper retaining member 16. The mounting tab 55 preferably includes ramped portions formed thereon for assisting the mounting of the mounting bracket 10 to the ignition coil assembly 48.

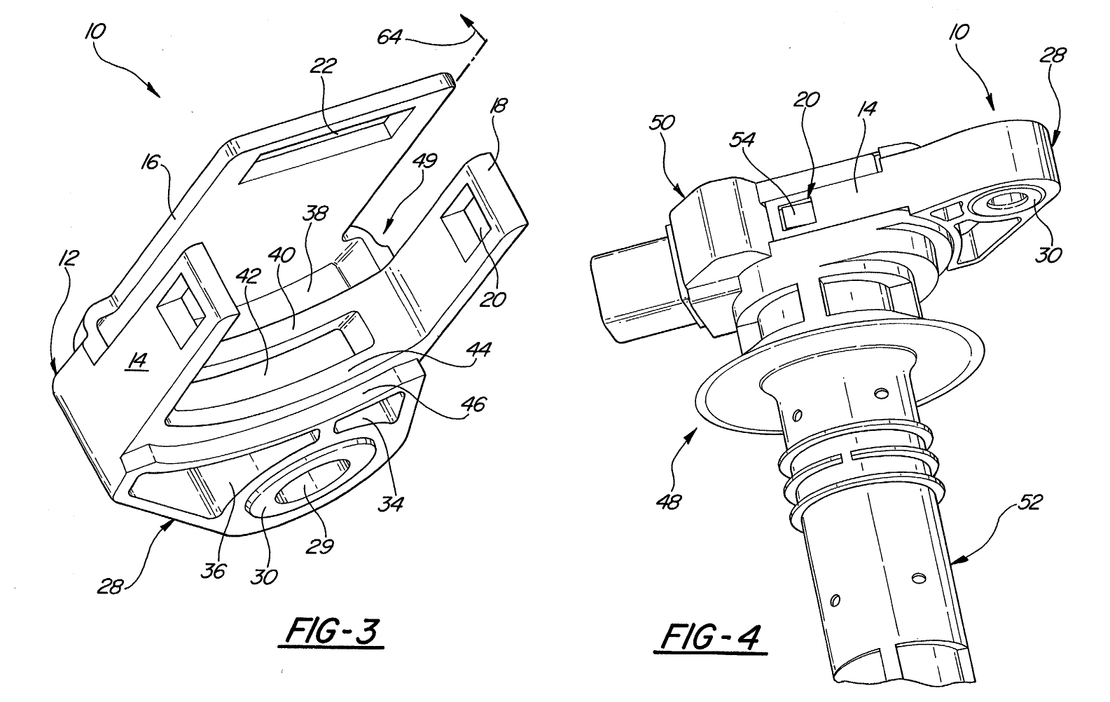

In operation, the mounting bracket 10 is releasably attached to the ignition coil assembly 48 by placing the side retaining members 14 in alignment with the mounting tabs 54 and the upper retaining member 16 in alignment with the mounting tab 55 and exerting a force on the mounting bracket 10. The ramped portions 18 allow the side retaining members 14 to deflect in an outward direction depicted by an arrow 62, best seen in FIG. 1, allowing the mounting tabs 54 to engage with the apertures 20 of the retaining members 14. The upper retaining member 16 deflects in an upward direction depicted by an arrow 64, best seen in FIG. 3, allowing the mounting tab 55 to engage with the aperture 22 in the upper retaining member 16. The tabs 54 and 55, working in conjunction with the ribs 40 and 44 and grooves 38, 42, and 46 in the mounting recess 49 that engage with the corresponding ribs and grooves (not shown) on the exterior surface of the ignition coil assembly 48, firmly engage the mounting bracket 10 to the ignition coil assembly 48. The mounting bracket 10 may be released from the ignition coil assembly 48 by exerting a force on the retaining members 14 and 16 sufficient to deflect the apertures 20 and 22 beyond the mounting tabs 54 and 55, enabling the mounting bracket 10 to be removed from the ignition coil assembly 48.

Alternatively, at least one of the side retaining embers 14 or the upper retaining member 16 does not include an aperture 20 or 22 extending therethrough. Alternatively, the upper retaining member 16 does not extend along the width of the bracket body 12 but does extend enough to block an upper surface of the ignition coil assembly 48.

Alternatively, the mounting tabs 54 and 55 on the ignition coil assembly 48 are spring-biased to assist in releasably attaching the mounting bracket 10 to the ignition coil assembly 48. Alternatively, the apertures 20 and 22 on the retaining members 14 and 16 are depressions (not shown) that do not extend through the retaining members 14 and 16 that engage with corresponding projections (not shown) formed on the surface of the ignition coil assembly 48. Alternatively, the apertures 20 and 22 and mounting tabs 54 and 55 are reversed wherein a plurality of mounting tabs (not shown) formed on the exterior surface of the retaining members 14 and 16 engage with a corresponding plurality of cavities (not shown) formed on the surface of the ignition coil assembly 48. Alternatively, the retaining members 14 and 16 include a plurality of projections (not shown) that releasably engage in a manner similar to gear teeth with a corresponding plurality of projections (not shown) formed on the surface of the ignition coil assembly 48. In addition to the above-mentioned alternatives, those skilled in the art will appreciate that numerous releasable attachment means and mounting means, whether attached to the bracket body 12, to the ignition coil assembly 48, or both, may be utilized for releasably attaching the mounting bracket 10 to the ignition coil assembly 48 without departing from the spirit or scope of the invention.

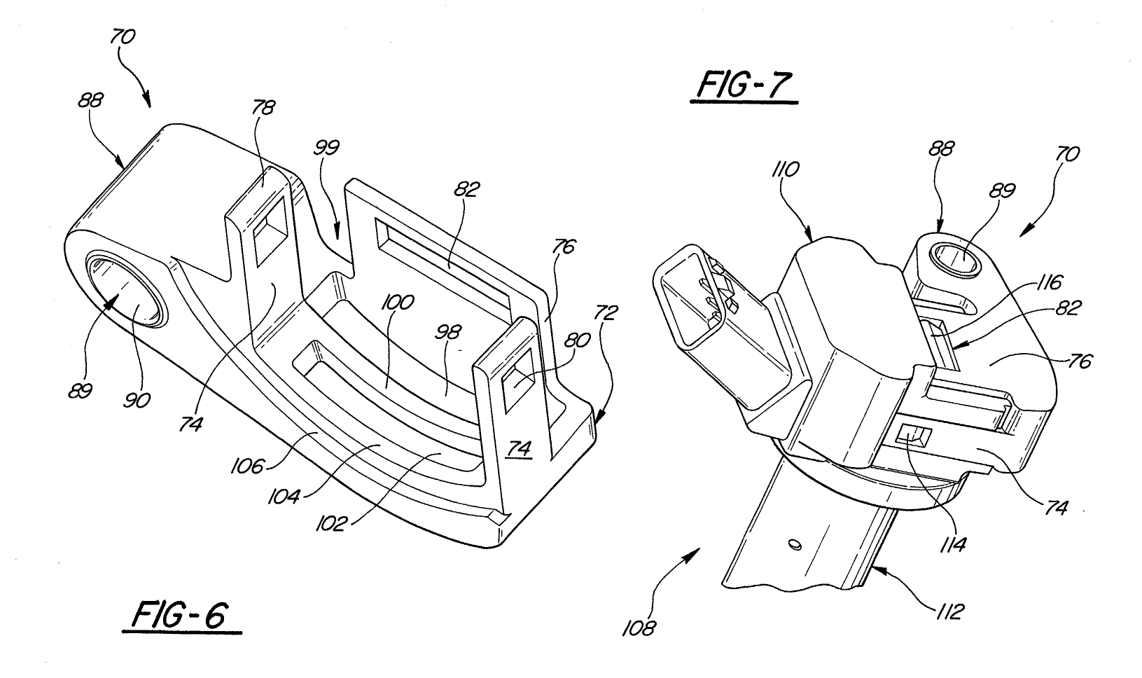

Referring now to FIG. 6, an alternative embodiment of a removable mounting bracket is indicated generally at 70. The mounting bracket 70 is preferably constructed of an injection molded plastic material, or other similar material. The mounting bracket 70 includes a bracket body 72 having two elongated, generally rectangular side retaining members 74 extending outwardly therefrom. An aperture 80 extends through each of the side retaining embers 74. The inner surface of a free end of each of the retaining members 74 includes a ramped portion 78 formed thereon.

An elongated, generally rectangular upper retaining member 76 having an upper surface and a lower surface extends outwardly from the bracket body 72. An aperture 82 extends through the upper retaining member 76.

An inner surface of the bracket body 72 bounded by the side retaining members 74 and the upper retaining member 76 includes a groove 98, a rib 100, a groove 102, a rib 104, and a groove 106, defining a mounting recess indicated generally at 99.

A mounting projection 88 extends from the bracket body 72 generally perpendicular to the side retaining members 74 and the upper retaining member 76. A generally cylindrical aperture 89 extends the mounting projection 88. The aperture 89 receives a generally tubular mounting insert 90. The mounting insert 90 is preferably constructed of aluminum, brass, thermoset plastic, or similar material. The mounting insert 90 is preferably sized to receive a fastener (not shown), such as a bolt, a rivet, or the like.

Referring now to FIG. 7, the mounting bracket 70 is shown attached to a pencil-type ignition coil assembly, indicated generally at 108, that is of a different design than the pencil-type ignition coil assembly 48. The ignition coil assembly 108 includes an upper portion 110 and a lower portion 112. A mounting tab 114 extends outwardly from opposed exterior surfaces of the upper portion 110 for engaging with the apertures 80 of the side retaining members 74. The mounting tabs 114 preferably include ramped portions formed thereon for assisting the mounting of the mounting bracket 70 to the ignition coil assembly 108. The grooves 98, 102, and 106 and the ribs 100 and 104 of the mounting recess 99 preferably interlock with corresponding ribs and grooves (not shown) on the exterior surface of the ignition coil assembly 108, reinforcing the connection between the bracket 10 and the ignition coil assembly 48. A mounting tab 116 extends upwardly from an upper exterior surface of the upper portion 110 of the ignition coil assembly 108 to engage with the aperture 82 in the upper retaining member 76. The mounting tab 116 preferably includes ramped portions formed thereon for assisting the mounting of the mounting bracket 70 to the ignition coil assembly 108.

In accordance with the provisions of the patent statutes, the present invention has been described in what is considered to represent its preferred embodiment. However, it should be noted that the invention can be practiced otherwise than as specifically illustrated and described without departing from its spirit or scope. For example, those skilled in the art will appreciate that the mounting projection could project from the bracket body in any direction to assist in mounting the mounting bracket to the mounting surface. In addition, the present invention could include more or less retaining members as dictated by the attachment requirements of the component.

What is claimed is:

1. A removable mounting bracket for attaching a component to a mounting surface comprising:
a bracket body having a mounting projection extending outwardly therefrom for cooperation with a fastener for fastening said bracket body to the mounting surface; and
a plurality of retaining members extending outwardly from said bracket body for cooperation with the component, at least one of said retaining members including a releasable attachment means for engaging a corresponding mounting means on the component.

2. The mounting bracket according to claim 1 wherein said releasable attachment means is an aperture formed in at least one of said retaining members, and said mounting means is at least one mounting tab formed on the component, said mounting tab releasably engaging a corresponding said aperture.

3. The mounting bracket according to claim 2 wherein said retaining members extend from said bracket body perpendicular to said mounting projection.

4. The mounting bracket according to claim 2 wherein each of said retaining members has an aperture formed therein.

5. The mounting bracket according to claim 1 including a plurality of ribs and grooves formed on said bracket body, said ribs and grooves cooperating with a corresponding plurality of ribs and grooves on the component.

6. The mounting bracket according to claim 1 wherein said mounting projection receives a mounting insert for cooperation with the fastener.

7. A removable mounting bracket for attaching an ignition coil assembly to a mounting surface, comprising:
a bracket body having a mounting projection extending outwardly therefrom for cooperation with a fastener for fastening said bracket body to the mounting surface; and
a releasable attachment means formed on said bracket body for engaging a corresponding mounting means formed on the component.

8. The mounting bracket according to claim 7 wherein said releasable attachment means is a plurality of elongated retaining members extending outwardly from said bracket body, at least one of said retaining members having an aperture formed therein, and said mounting means is a plurality of mounting tabs formed on the component, each of said mounting tabs releasably engaging a corresponding aperture.

9. The mounting bracket according to claim 8 wherein said retaining members extend from said bracket body perpendicular to said mounting projection.

10. The mounting bracket according to claim 8 wherein each of said retaining members has an aperture formed therein.

11. The mounting bracket according to claim 8 including a plurality of ribs and grooves formed on said bracket body, said ribs and grooves cooperating with a corresponding plurality of ribs and grooves on the component.

12. The mounting bracket according to claim 8 wherein said mounting projection receives a mounting insert for cooperation with the fastener.

13. The mounting bracket according to claim 8 wherein the component is one of a pencil-type ignition coil assembly and a coil-on-plug-type ignition coil assembly.

14. An assembly for attaching a component to a mounting surface on a vehicle, said assembly comprising:
a component having a plurality of mounting tabs formed thereon;
a bracket body having a mounting projection extending outwardly therefrom for attaching said bracket body to the mounting surface; and
a plurality of elongated retaining members extending outwardly from said bracket body, at least one of said retaining members having an aperture formed therein, each of said mounting tabs releasably engaging a corresponding one of said apertures.

15. The mounting bracket according to claim 14 wherein said retaining members extend from said bracket body perpendicular to said mounting projection.

16. The mounting bracket according to claim 14 wherein each of said retaining members has an aperture formed therein.

17. The mounting bracket according to claim 14 including a plurality of ribs and grooves formed on said bracket body, said ribs and grooves cooperating with a corresponding plurality of ribs and grooves on said component.

18. The assembly according to claim 14 wherein said component is one of a pencil-type ignition coil assembly and a coil-on-plug-type ignition coil assembly.

19. The assembly according to claim 14 including a fastener for attaching said mounting bracket and said component to the mounting surface.

20. The assembly according to claim 19 wherein the mounting surface is one of a valve cover, a cam cover, and a cylinder head.
